(19) United States
(12) Patent Application Publication
(10) Pub. No.: US 2006/0130708 A1
(43) Pub. Date: Jun. 22, 2006

(54) Formulation of high mechanical strength ceramic stuccoes for decoration finishing in internal and external walls and process thereof

(76) Inventors: Luis Arturo Calva Garcia, Bosques de las Lomas (MX); Norma Selene Sosa Ramirez, Bosques de las Lomas (MX)

Correspondence Address: Law Office of Carmen Pili Eckstrom, 727 Sunshine Dr, Los Altos, CA, 94024, US

(21) Appl. No.: 11/104,207

(22) Filed: Apr. 12, 2005

(30) Foreign Application Priority Data
Dec. 16, 2004 (MX) PA/A/2004/012774

(51) Int. Cl. C04B 16/00; C04B 14/00

(52) U.S. Cl. 106/712

(57) ABSTRACT

The instant invention relates to improved ceramic stucco formulations based on marmorinos, mortars and Portland cements, characterized because they include an organic additive mixture based on methyl hydroxyl cellulose, sodium melamine sulphonate, stearate, polyvinic compounds in a large percentage and large grain marble carbonate giving to said formulations a high beginning of setting and a better adherence forming a paste with texturized paste type granules, for rougher finishing in a plastering application on any type of walls and manufacturing process.

### BACKGROUND OF THE INVENTION

1. Field of the Invention

The instant invention relates to improved ceramic stucco formulations (Tecnomuro AR) based on large grain marmorinos, Portland cements modified with organic additives giving a high beginning of setting and, above all, a better adherence because of a larger quantity of resin, forming a paste with larger size granules for finishings similar to texturized paste in plastering any type of walls and ornament finishings in internal or external walls.

2. Description of the State of the Art

Several mixtures of stucco and mortars have been known since the antiquity, mixing different types of lime with sand and water for application; recently said mixtures have been modified with additives to be aggregated to the mortar or stucco to change its physical behavior. The additives can be pozzolans, blood, animal or vegetal fibers, cactus juice, clays, etc., that improve the adherence properties.

Improved mixtures with the incorporation of hydraulic cement to increase the hardness specification or with Portland plastic cement are also known.

Thus, for example, in patent application PCT/US00/25907 a typical composition of cement used as mortar or stucco is describes, said composition is based on: Portland cement, lime, pozzolanic material, selected from class “F” volatile ashes, class “C” ashes and class “N” pozzolanic materials and mixtures of pozzolanic material in different percentages.

In our issued Mexican patent application PA/a/2004/010631, a stucco composition is described to cover walls, the main characteristic of which is to present a good granulometric profile for fine finishings that does not require higher adherence or a lower granule thickness.

### BRIEF DESCRIPTION OF THE DRAWINGS

FIG. 1 is a Process Flow Chart

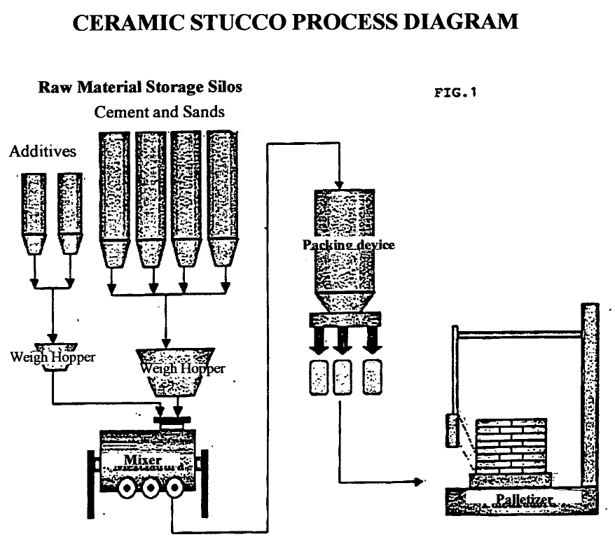

FIG. 2 is a Diagram showing particle size distribution.

The instant invention relates to an improved special mixture called high resistance stucco based on marmorinos with Portland cement granule increased up to 2.5 mm, inert fibers, chemical viscosity additives and increased adherence compounds that upon being mixed with fresh water are transformed in a paste ready to be laid as finishing on blocks, bricks, cellular concrete, polystyrene panels or on any common plastered surface or on low porosity walls.

The high strength (AR) stucco (Tecnomuro AR) object of the instant invention substitutes the traditional system of plaster application (laying and alignment), through a system of one or two layer finishing, offering great economic advantages as well as great advantages with regard to the administration of materials and time saving.

The preferred ceramic stucco composition (AR) of the instant invention is a mixture presenting the following formulation:

| | % Recommended |
|---|---|
| Raw material | by weight |
| Large grain Thick Marmorino 0-2.5 mm | 80-85 |
| White or Gray Portland Cement | 15.5-17 |
| Methyl Hydroxyethyl Cellulose | 0.1-0.25 |
| Sodium Melaminesulphonate | 0.01-0.08 |
| Aluminum Stearate | 0.1-0.25 |
| Calcium Formiate | 0.1-0.25 |
| Cellulose Fiber | 0.15-0.30 |
| Polyvinyl acetate resin | 1.0-2.0 |
| Pigments | 0.01-4.0 |

Because of its excellent properties, the Stucco formulation AR is adequate for finishings similar to a texturized paste with thicknesses of up to 2.5 mm directly applied onto the masonry.

The components of the formulation present, respectively, the following characteristics:

Binder and Hardener:

Portland Cement (15.5-17% by Weight)

It is a basic element to bind the elements of the formulation besides starting and maintaining the hardening, as well as the mechanical strength; Portland cement is the basis of the plastering mortars.

Petreous Aggregate:

Large Grain Marmorino (Marble Carbonate) 0-2.5 mm (80-85% by Weight)

It is a petreous mineral aggregate of controlled granulometry giving the mortar an excellent whiteness that makes it easy to pigment the stucco and thus to obtain colored coatings. Its particle size distribution allows it to be bound by the cement in a balanced way.

Moisture Retainer and Thickener:

Methyl Hydroxyethyl Cellulose (0.1-0.25% by Weight)

It is a component used in stucco formulation, mainly to retain the moisture contained in the moistened mortar; said property helps delay the hardening time; moreover it also considerably increases the manageability of the mortar, making it a malleable paste.

Air Entrainer Agent:

Sodium Melaminesulphonate (0.01-0.08% by Weight)

This inhibiting component in the stucco formulation generates air inclusion within the mortar reaching 12% by weight of air inclusion. Particularly, this additive helps diminish the moisture level for the development of the paste, improving strength because it allows a good manageability of the mortar, preventing moisture excess.

Water Proofing Agent:

Aluminum Stearate (0.1-0.25% by Weight)

This additive is used to lower the permeability generated in a cement based system and to lower the efflorescence generated by the mortar itself.

Additive to Regulate the Setting Time:

Calcium Formate (0.1-0.25% by Weight)

This additive accelerates the beginning of the setting, the formulations containing thickening agents tend to retain moisture in such a way as to considerably delay the beginning of the setting, said additive accelerates this process without affecting the original moisture retention given by the thickening agent.

Additive to Prevent Paste Detachment

Cellulose Fiber (0.15-0.30% by Weight)

Because the mortar paste tend to come off when it is applied, the cellulose fiber prevent the detachment of the paste once it is applied.

Vinylic Resin:

Polyvinyl Acetate Resin (1.0-2.0% by Weight)

Besides increasing the contact adherence to the mortar, this additive also works as plasticizing agent, giving the mortar a grater flexibility degree than any other conventional stucco; moreover, it use is not limited to porous surfaces because the increase in contact adherence makes it easier to apply it on low porosity surfaces because, upon notably increasing its percentages in the formulation, it can adhere a larger granule profile.

Pigments:

Pigments (0.01-4.0% by Weight)

All the pigments used are appropriate to be combined with cement; because of their alkalinity, some pigments do not allow a good development while the mortar recovers its strength, besides said pigments show good UV strength.

The differences between Mexican patent application PA/a/2004/010631 and the stucco of the instant invention is characterized because the mechanical strength and adherence are increased through a major use of polyvinyl acetate resins permitting major flexibility and major crumbling and scratching strength.

Hereinafter the characteristics or specifications of our stucco formulation are described compared to other commercial stuccos (Table 1).

TABLE 1

| Mortar properties | P-1 | P-2 | P-3 |
|---|---|---|---|
| Water factor | 16 | 20 | 21 |
| Cracks | NO | NO | NO |
| Workability | GOOD | REGULAR | GOOD |
| Crumbling | NO | NO | YES |
| Adherence | GOOD | GOOD | BAD |
| Water retention | 98.81 | 98.33 | 98.12 |
| Powder density | 1.75 | 1.64 | 1.59 |
| Paste density | 1.99 | 1.93 | 1.95 |
| Beginning of setting | 4.5 | 4 | 6.5 |
| End of setting | 6.5 | 7 | 10 |
| Tensile strength | 0.44 | 0.3 | 0.25 |
| Compression strength | >10 | 7 | 14 |

| Mortar properties | P-4 | P-5 | Units |
|---|---|---|---|
| Water factor | 18.5 | 19 | % |
| Cracks | No | No | — |
| Workability | GOOD | GOOD | — |
| Crumbling | No | No | — |
| Adherence | GOOD | EXCELLENT | — |
| Water retention | 98.75 | 98.53 | % |
| Powder density | 1.65 | 1.56 | g/cm³ |
| Pasta density | 1.97 | 1.78 | g/cm³ |
| Beginning of the setting | 5.5 | 4.5 | hours |
| End of setting | 7 | 7.0 | hours |
| Tensile strength | 0.51 | 0.80 | N/mm² |
| Compression strength | 6.2 | 5.9 | N/mm² |

P (1-3) Commercial stuccos
P-4 Mexican patent application
P-5 Stucco of the instant invention

According to table 1:
An important aspect of the composition of the invention is that the product presents the highest beginning time of setting on the market; this benefit is reflected on the working time for the installer, after having prepared his or her mixture, because this gives a longer life time to the prepared material.
Another aspect is the adherence of the product which is better than the one of the evaluated products, because its high resin contents makes it highly adhesive, besides forming a plastic layer protecting the product and improving its mechanical properties, it is observed that Tecnomuro AR also presents a larger grain size than the normal Tecnomuro (Mexican patent application) besides showing a more uniform particle size distribution compared to large grain commercial products. This property gives Tecnomuro AR the possibility to be laid in thicknesses up to 25 mm on any type of walls. Besides, rougher finishings can be made that are similar to a texturized paste.
Workability: The term workability refers to the consistency of the material; the cement based products are generally hard, but the addition of thickeners (methyl hydroxyethyl cellulose) help the mixture get a creamy consistency that is easy to handle; moreover a special grade of thickener has to be used to avoid that the formed paste adheres onto the working tools. It is very important to use special grade of thickeners because the traditional cellulose products promote the adherence of fresh mortar onto the working tools.

The determination of the granulometric profile characteristics of the stucco is presented in the following table 2 with comparative products 1, 2 and 3 Tecnomuro AR, object of the instant invention and Mexican patent application.

TABLE 2
Grain size (mm)

| STUCCO | 2.5 | 2 | 1 | 0.8 | 0.63 | 0.5 |
|---|---|---|---|---|---|---|
| 1 | 0.1 | 3.9 | 18 | 17.9 | 18 | 18.9 |
| 2 | 0 | 0 | 0.1 | 4.4 | 17.3 | 26.9 |
| 3 | 0 | 0 | 0 | 1 | 5.7 | 12.7 |
| STUCCO | 0 | 0 | 0 | 1.5 | 2.35 | 3.85 |
| Mexican patent | | | | | | |
| Application | | | | | | |
| Tecnomuro | 1.0 | 4.5 | 7.2 | 10.3 | 14.1 | 19.0 |
| A.R. | | | | | | |
| STUCCO | 0.4 | 0.315 | 0.2 | 0.1 | 0 | |
| 1 | 28.6 | 48.1 | 65.7 | 68.7 | 100 | * |
| 2 | 32.3 | 36.8 | 44.3 | 59.7 | 100 | * |
| 3 | 18.25 | 25.15 | 39.2 | 60.55 | 100 | * |
| STUCCO | 8.35 | 17.1 | 32.5 | 53.2 | 100 | * |
| Mexican patent | | | | | | |
| Application | | | | | | |
| Tecnomuro | 24.1 | 31.3 | 47.1 | 63.3 | 100 | * |
| A.R. | | | | | | |

* % accumulated

The product specification (stucco) are indicated hereinafter in Table 3

TABLE 3

| Characteristic | Range | Unit | Reference method |
|---|---|---|---|
| Granulometry | 0-2.5 | mm | ASTM C-3136-969 |
| Specific weight in | 1.5-1.9 | gr/cm³ | UNE EN-1015-6 |
| paste | | | |
| Water retention | 98-99 | % | UNE EN-1015-13 |
| Air contents | 10.5-12.0 | % | UNE EN-1015-7 |
| Pot-life | 4-6 | hrs. | UNE EN-480-2 |
| Adherence | 0.8-1.2 | N/mm² | UNE EN-1015-12 |
| Compression | 5-7 | N/mm² | UNE EN-1015-11 |
| strength | | | |
| Water absorption | 3-5 | % | UNE EN-1015-18 |
| Crumbling | 0 | % | INTERNAL |

Manufacturing Process of Ceramic Stuccos:

According to the block diagram, a raw material load is prepared based on cement aggregates and sands stored in silos in a ratio of 1500 Kg for each 50 Kg of additives, also placed in silos. They are progressively unloaded into corresponding hopper the feeding a mixer having a capacity of 2000 Kg. Then, the process continues according to Tables (A) and (B)

(A)
PRODUCTION ELEMENTS

| Storage | Conditions |
|---|---|
| Aggregate silos | Utilization level |
| Additive silos | Utilization level |
| Load (formulation) | Conditions |
| Aggregate Weigh Hopper | calibrated (1,500 Kg) |
| Additive Weigh Hopper | calibrated (50 Kg) |
| Operation | Characteristics |
| Mixer (2000 kg) | 4 mixing tools |
| Packaging | 3 filling openings |
| Palletizer | sack closing and final |
| | palletizing |

(B)
PROCESS CONDITIONS

| | STUCCO | | |
|---|---|---|---|
| | PORCELANITE | UNIT | OBSERVATIONS |
| LOAD PER BATCH | 1500 | Kg. | Room Temperature |
| MIXING TIME | 240 | Sec. | Room Temperature |
| No. OF MIXING | 4 | PZA | — |
| TOOLS | | | |
| BAG TYPE | 20 | Kg. | — |
| PALLET | 1200 | Kg. | — |

In Table 4, the yield of stucco is described with regard to coated area.

TABLA 4

| Characteristics | Range | Unit |
|---|---|---|
| Presentation | 20 | Kg |
| Application | Manual y projectable | — |
| Water for paste | 4.5-5.0 | liters |
| preparation | | |
| Yield on Blocks | 3.0-3.5 | m² per sack |
| Yield on concrete wall | 4.0-4.5 | m² per sack |
| Yield on brick wall | 2.5-3.0 | m² per sack |
| Yield on plasterboard | 4.0-4.5 | m² per sack |

The cost per square meter of stucco covering already with the desired pigmentation is up to 30% lower compared to any ordinary plaster finishing and also shows workability advantages because it is possible to make finishings with decorative figures as in the case of any commercial texturized paste because of its granulometry profile. It is recommended to wear gloves and glasses for its handling because of its alkaline pH.

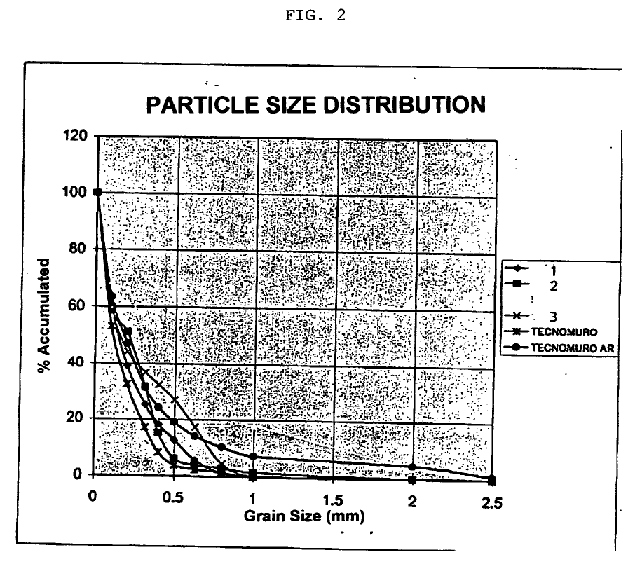

As can be seen on the graph of FIG. 2, the accumulated concentration of particle size from 2.5 mm to its maximum accumulated percentage concentrates the grain size up to 100% of the studied material.

The stucco composition is also characterized because it forms a ceramic stucco coat made of a layer with improved detachment resistance during the application procedure, better adherence onto the wall without forming cracks and a better cohesion between the particles through the use of methyl hydroxyethyl cellulose compound with good dissolution characteristics in cold water and high viscosities, stable in a variety of pH.

It is to be understood that the above reference arrangements are illustrative of the application of the principles of the instant invention. Numerous modifications and alternative arrangements can be devised without departing from the spirit and scope of the present invention while the present invention has been shown in the drawings and described above in connection with the exemplary embodiment of the invention. It will be apparent to those of ordinary skill in the art that numerous modifications can be made without departing from the principles and concepts of the invention as set forth in the claims.

1. A ceramic stucco formulation of high mechanical strength comprising:
a) a binder/hardener to bind the elements of the formulation and maintain hardening;
b) a petreous aggregate having controlled granulometry to provide whiteness;
c) a moisture retainer and thickener to retain moisture contained in formulation;
d) an air entrainer agent to generate air inclusion;
e) a water proofing agent to lower permeability;
f) additives to regulate setting time;
g) additives to prevent detachment;
h) vinylic resin to increase contact adherence and flexibility; and
i) pigments.

2. The ceramic stucco formulation according to claim 1 wherein the binder and hardener is white or gray Portland cement.

3. The ceramic stucco formulation according to claim 1 wherein the petreous aggregate is large grain marmorino or marble carbonate.

4. The ceramic stucco formulation according to claim 1 wherein the moisture retainer and thickener is methyl hydroxyethylcellulose.

5. The ceramic stucco formulation according to claim 1 wherein the air entrainer agent is sodium melamine sulphonate.

6. The ceramic stucco formulation according to claim 1 wherein the water proofing agent is aluminum stearate.

7. The ceramic stucco formulation according to claim 1 wherein the additives to regulate setting time is calcium formiate.

8. The ceramic stucco formulation according to claim 1 wherein the additives to prevent detachment is cellulose fiber.

9. The ceramic stucco formulation according to claim 1 wherein the vinylic resin is polyvinyl acetate resin.

10. The ceramic stucco formulation according to claim 1 wherein the pigment is selected from the group consisting of organic and inorganic colorant.

11. The ceramic stucco formulation according to claim 1 wherein the water proofing agent lowers efflorescence generated by the mortar itself.

12. The ceramic stucco formulation according to claim 1 wherein the additive which regulates setting time accelerates beginning of setting without affecting original water retention provided by a thickening agent.

13. The ceramic stucco formulation according to claim 1 wherein the petreous aggregate is large grain marmorino or marble carbonate is 0.0 to 2.5 mm.

14. The ceramic stucco formulation according to claim 1 wherein the effective amount of petreous aggregate is 80 to 85% by weight.

15. The ceramic stucco formulation according to claim 1 wherein the effective amount of the binder/hardener of 15.5 to 17% by weight.

16. The ceramic stucco formulation according to claim 1 wherein the effective amount of the moisture retainer and thickener is up to 0.1 to 0.25% by weight.

17. The ceramic stucco formulation according to claim 1 wherein the effective amount of the additives to regulate setting time is 0.1 to 0.30% by weight and additives to prevent detachment is up to 0.30% by weight.

18. The ceramic stucco formulation according to claim 1 wherein the effective amount of vinylic resin is 1.0 to 2.0% by weight.

19. The ceramic stucco formulation according to claim 1 wherein the effective amount of air entrainer agent is 0.01 to 0.08% by weight.

20. The ceramic stucco formulation according to claim 1 wherein the effective amount of water proofing agent is 0.1 to 0.25% by weight.

21. The ceramic stucco formulation according to claim 1 wherein the effective amount of pigment is 0.01 to 4.0% by weight.

22. The ceramic stucco formulation according to claim 1 wherein said formulation shows a granulometric profile having values of from 1.0 to 2.5 mm, similar to a texturized thick paste, crumbling resistant and highly adhesive.

23. The ceramic stucco formulation according to claim 1 further comprising allowing a larger grain size and a uniform particle size distribution and compression strength of 5.9 N/MM² which can be applied in thicknesses of up to 25 mm with tensile strength of 0.80 N/MM².

24. The ceramic stucco formulation of high mechanical strength according to claim 1 having one or more features selected from the group consisting of:
a) a binder/hardener of 15.5 to 17% by weight;
b) a petreous aggregate of up to 85% by weight;
c) a moisture retainer and thickener of up to 0.30% by weight;
d) an air entrainer agent is up to 0.8% by weight;
e) a water proofing agent of up to 0.3% by weight;
f) additives to regulate setting time of 0.1 to 0.30% by weight;
g) additives to prevent detachment is up to 0.3% by weight;
h) vinylic resin of 2% by weight; and
i) pigments of from 0.1 to 4% by weight.

25. The ceramic stucco formulation of high mechanical strength according to claim 24 having one or more features selected from the group consisting of:
a) the binder/hardener is white or gray Portland cement;
b) the petreous aggregate is large grain marmorino or marble carbonate;
c) the moisture retainer and thickener is methyl hydroxy ethylcellulose.
d) the air entrainer agent is sodium melamine sulphonate.
e) the water proofing agent is aluminum stearate.
f) the additives to regulate setting time is calcium formiate;
g) the additives to prevent detachment is cellulose fiber;
h) the vinylic resin is polyvinyl acetate resin; and
i) the pigment is selected from the group consisting of organic and inorganic colorant.

26. The ceramic stucco formulation of high mechanical strength according to claim 1 having one or more features selected from the group consisting of:
a) a binder/hardener of 15.5 to 17% by weight; a petreous aggregate of 80-85% by weight; a moisture retainer and thickener of 0.1 to 0.25% by weight;
b) an air entrainer agent is 0.01 to 0.8% by weight;
c) a water proofing agent of 0.1 to 0.25% by weight;
d) additives to regulate setting time of 0.1 to 0.25% by weight;
e) additives to prevent detachment of 0.15 to 0.3% by weight;
f) vinylic resin of 1.0 to 2% by weight; and
g) pigments of from 0.001 to 4.0% by weight.

27. A method for the preparation of ceramic stucco formulation according to claim 1 comprising the steps of:
a) providing a mixture comprising a load of aggregate materials based on white or gray Portland cement in a 15.5-17% ratio by weight with large grain marmorino, 0.01-2.5 mm in an 80-85% ratio by weight; and
b) combining the mixture in (a) simultaneously in a mixer with an additive load based on a mixture of: methyl hydroxyethyl cellulose in a weight ratio of 0.25%, sodium melamine sulphonate at 0.01-0.08% by weight; aluminum stearate at 0.1-0.25% by weight; calcium formiate at 0.1-0.25% by weight, cellulose fiber at 0.15-0.30% by weight; polyvinyl acetate resin at 1.0-2.0% by weight and organic or inorganic pigments, from 0.0 to 4.0%; by weight with a mixing time of 200-240 seconds at room temperature.

28. A method of using the ceramic stucco formulation of high mechanical strength according to claim 1 against crumbling for ornament finishing, on internal and external walls, for manual finishing applications or finishing application by any other means.
